(19) United States
(12) Patent Application Publication
(10) Pub. No.: US 2021/0241110 A1
(43) Pub. Date: Aug. 5, 2021

(54) ONLINE ADAPTATION OF NEURAL NETWORK COMPRESSION USING WEIGHT MASKING

(71) Applicant: EMC IP Holding Company LLC, Hopkinton, MA (US)

(72) Inventors: Tiago Salviano Calmon, Rio de Janeiro (BR); Vinicius Michel Gottin, Rio de Janeiro (BR); Paulo Abelha Ferreira, Rio de Janeiro (BR)

(21) Appl. No.: 16/777,200

(22) Filed: Jan. 30, 2020

(51) Int. Cl. G06N 3/08; G06N 3/04

(52) U.S. Cl. CPC G06N 3/082; G06N 3/04

(57) ABSTRACT

Dynamic adapting neural networks. A latency of a neural network, such as time to inference, is controlled by dynamically compressing/decompressing the neural network. The level of compression or the compression ratio is based on a relationship between the latency and the desired service level. The compression ratio and thus the level of compression can be adjusted until the latency complies with a required latency. A minimum level of accuracy is maintained such that catastrophic forgetting does not occur in the neural network.

### FIELD OF THE INVENTION

Embodiments of the present invention generally relate to artificial intelligence, machine learning, and/or neural networks. More particularly, at least some embodiments of the invention relate to systems, hardware, software, computer-readable media, and methods for neural networks and to dynamically compressing neural networks.

### BACKGROUND

Artificial Intelligence (AI) and Machine Learning (ML) are becoming more pervasive in modern life. Many governments rely on AI and ML for various task such as surveillance, police force management, and traffic prediction. Companies rely on AI and ML to generate richer insights about markets, finance and also to aid engineering and product development. Many applications are made possible by AI and ML and many applications are being developed to incorporate their advantages.

ML is often used for real-time and near real-time analytics. These are applications where it is critical to have strict latency requirements over the insights generated by the ML system. For instance, a bot buying and selling stocks needs not only to know what to buy with great accuracy, but the bot needs to know when to buy, and needs to know this information in real-time or with as little latency as possible.

For these types of applications, deep neural networks (DNNs), which are examples of ML, are often employed. DNNs come in various forms, including convolutional, recurrent, attention-based, residual, and the like. The merits of DNNs are related to redundancy. In other words, adding many parameters to the DNNs allows optimal accuracy to be achieved in multiple ways. While this is a feature that allows DNNs to outperform more traditional ML algorithms, there is a corresponding cost. More specifically, performing inferences and all of the associated operations consumes time and energy. This often makes it difficult to comply with hard constraints on the ML system.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates an example of a neural network that is configured to be dynamically compressed and/or enlarged;

FIG. 2 discloses an example of a pipeline engine, that is part of a neural network engine, that is configured to generate or determine a relationship between a current compression ratio and a latency parameter;

FIG. 3 illustrates an example of a compressed neural network;

FIG. 4 illustrates another example of a compressed neural network;

FIG. 5 illustrates an example of a graph illustrating a minimum acceptable accuracy; and

FIG. 6 illustrates an example of a method for dynamically compressing and/or re-enlarging a neural network.

### DETAILED DESCRIPTION OF SOME EXAMPLE EMBODIMENTS

Embodiments of the present invention generally relate to artificial intelligence (AI), machine learning (ML) and/or neural networks (NN) including deep neural networks (DNNs). More particularly, at least some embodiments of the invention relate to systems, hardware, software, computer-readable media, and methods for automatically and/or dynamically adapting neural network compression ratios in the context of, by way of example only, ML and/or AI. Embodiments of the invention further relate to systems and methods for automatically and/or dynamically adapting neural network compression ratios using a masked approach.

Artificial Intelligence and Machine Learning are being applied to many different spaces for a wide variety of reasons. AI often rely on cloud-based deployment or on-premises deployment in order to be accessible. In some applications, however, inferences provided by ML needs to be assessed in real-time. This is common in edge computing paradigms and/or in Internet of Things (IoT) scenarios.

The inferences are often provided by DNNs. Consequently, DNNs can be associated with heavy workloads, competing workloads, poor network conditions, and other disruptions. Each of these conditions can impact the time to obtain an inference. As previously stated, this may not be tolerable in some situations and environments. Embodiments of the invention dynamically compress neural networks by keeping a network structure and a masking parameter. The masking parameter can change over time and is an example of an automatic mechanism to shrink and enlarge or re-enlarge neural networks over time. This achieves improved performance for any given requirement, such as a latency requirement.

More specifically, many applications, which may leverage edge computing environments, are time sensitive. Edge computing paradigms may rely on the virtualization of edge devices to serve applications with tighter or harder latency requirements. Thus, there is growing computational power in edge devices such as smartphones, gateways, smart network interface controllers, and the like. However, energy consumption is still a concern and it would be advantageous to perform good-enough inference and it would also be advantageous to perform good enough inference a while conserving energy.

One way to cope with these concerns is through neural network compression. Neural network compression effectively reduces the number of operations performed in the neural network while losing the least performance in terms of accuracy. By reducing the number of operations performed, the latency of the inference is reduced.

Compression techniques may include, by way of example only, constructive, destructive, and quantization. Constructive methods construct a small neural network from scratch while spending limited resources in terms of memory. The other two methods, destructive and quantization, work by pruning a full-fledged neural network using some heuristic and reducing the representation size of weights and activations, respectively.

In one example, embodiments of the invention rely on a destructive and/or quantization method for dynamically changing the size of a neural network. While embodiments allow for a neural network to be compressed, the network can also be re-enlarged when possible. The destruction percentage can be adaptively changed with respect to a measured latency. A desired latency level is used to control the level of pruning of or compression ratio of the neural network. This allow the operator to set strict latency Service Level Objective (SLO) and have the best possible inference while respecting this hard constraint. Embodiments of the invention allow real-time applications to have and implement strict latency constraints or satisfy other requirements.

A characteristic of real-time applications is the unpredictability of several components, such as but not limited to network conditions, number of requests per time, and concurrency, among others. To cope with these components and their unpredictability, a conventional approach is to provide a static and more extreme solution. To follow the example of a neural network, a very large pruning percentage or compression ratio could be employed to be sure upfront that constraints will be enforced. To do so, the possible magnitudes of disturbances in network conditions and the maximum demand for an inference service needs to be known. Unfortunately, this usually cannot be known with certainty upfront, which leads to probabilistic assumptions over the proper working of the mechanism in terms of latency.

Because real-time applications may have very strict constraints on latency, real-time applications that use neural network inference is sometimes infeasible. To cope with this situation, the current approach is to apply an extreme level of compression. This allows the application to comply with the latency constraint even with poor conditions in the neural network, concurrency, etc. This type of extreme compression, however, comes at the cost of accuracy. In other words, this approach often results in unacceptable accuracy.

Another issue comes with environmental changes. The execution environment is always subject to disturbances of some nature, and adapting to these disturbances is a difficult task. Furthermore, the conditions for each user might be different, which might require tailored adaptation for each need. Achieving the proper compression ratio manually is cumbersome and error prone.

Embodiments of the invention automatically adapt a neural network compression ratio using a masked approach. Generally, the measured latency, which may be an average, is compared to a desired latency for an inference. The resulting error parameter or signal defines whether additional compression is required for a faster inference time or whether less compression can be applied in order to achieve better accuracy. Alternatively, the same compression level can be maintained.

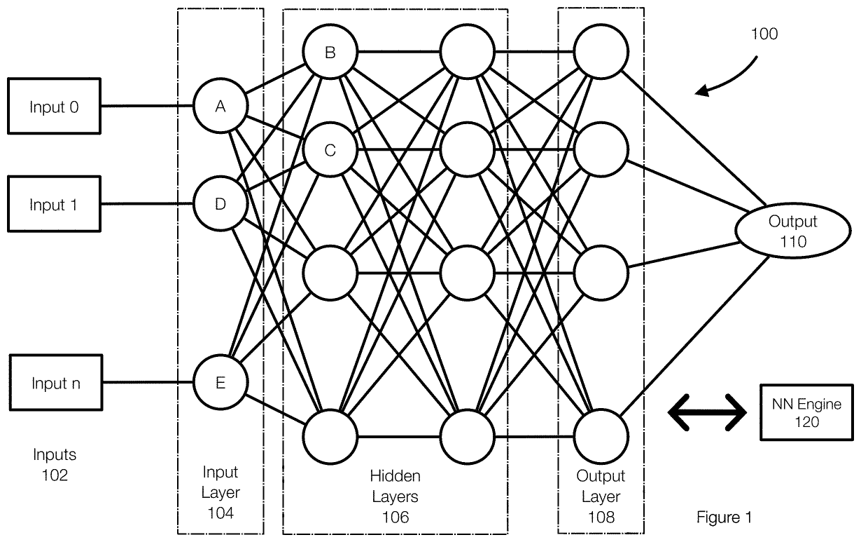

FIG. 1 illustrates an example of a neural network (e.g., a deep neural network). The neural network 100 shown in FIG. 1 is typically represented by layers of interconnected nodes. FIG. 1 illustrates nodes that are interconnected in a non-limiting manner. The neural network 100 includes inputs 102 (input 0, input 1, . . . , input n). The inputs 102 are provided to an input layer 104. The input layer 104 may include a plurality of nodes. Each node, by way of example only, is connected to one of the inputs 102.

The neural network 100 also includes hidden layers 106 and an output layer 108. The neural network 100 can include any number of layers and each of the layers 104, 106, and 108 includes one or more nodes. FIG. 1 also illustrates multiple connections between the nodes. However, actual neural networks may have different connections (e.g., every node in one layer may not be connected to every node in another layer). Further, the connections are not limited to connections from one layer to the next layer.

In this example, the input layer 104 is configured to receive the inputs 102 (e.g., a value, a signal, data, or the like). The hidden layers 106 are a collection of nodes (or neurons) that have connections to other nodes. FIG. 1 illustrates an arrangement where each layer is connected to a subsequent layer, but other layer and node arrangements are possible.

In this example, each of the connections between the nodes represents a weight. For example, if the connection between node A and node B has a higher weight that the connection between node A and node C, then the node A may influence the node B more than the node C. More generally, the value of the weight (which may be positive or negative) has an impact on the ultimate output 100 or on the inference. A weight near zero, for example, may not have much influence in the neural network 100. A negative weight may decrease the output 110. Generally, the weights decide how much influence the input has on the output (whether it be the output for a particular node or the over all output or inference of the neural network). For example, the node B has connections with the nodes A, D and E. The node B may generate an output whose value corresponds to the sum of the inputs multiplied by the weights of the connections. Thus, the output of B=Input₀*w_{A}+Input₁*w_{B} + . . . +Inputₙ*wₙ. This output of B is provided to each of the nodes in the next layer in this example to which the node B is connected. In this manner, the inputs 102 propagate through the neural network 100, operations are performed at the nodes, and the output 110 is generated. In some examples, multiple outputs or inferences may be generated. Because all of the nodes are performing computations, there is necessarily a delay from the time the inputs are received to the time that the inference or output 110 is generated.

FIG. 1 illustrates a neural network engine 120 that is configured to dynamically adapt the size of the neural network 100. The neural network engine 120 may implement, as previously stated, a destructive method to dynamically change the size of the neural network 100. The destruction percentage or compression ratio is measured with respect to measured latency and a desired latency level is used to control the pruning of the neural network. This allows the neural network to be compressed such that the best inference or output is obtained with respect to a hard constraint such as a hard latency requirement.

More specifically, an error signal between the measured latency and the desired latency for inference is used to adjust the compression ratio applied to the neural network 100.

Embodiments of the invention learn a relationship between the inference time (e.g., the time for the neural network to generate an output) and a level of compression applied to the neural network. In one example, a dynamic model is continuously adapted to learn this relationship. The dynamic model allows a compression ratio to be implemented that achieves a desired SLO for the neural network 100.

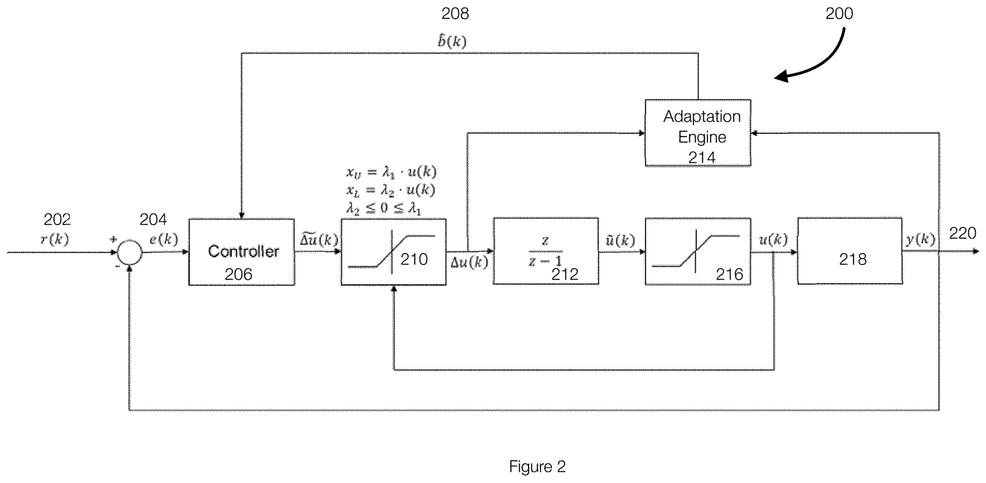

FIG. 2 illustrates an example of a pipeline engine 200, which may be included in the neural network engine 120. The pipeline engine 200 is configured to dynamically adapt the compression ratio applied to a neural network. In one example, the control strategy is implemented using a first order model represented by:

x(k+1)=a·x(k)+b·u(k) Equation 1

In this example, Equation 1 is a first-order differential equation with parameters to be discovered used as a system model for the relation between compression ratio and the SLO metric.

In FIG. 2 and Equation 1, u(k) represents the level of compression, y(k) represents the current latency time for inference, and r(k) is the desired latency time for inference. In this example, the desired latency 202 is summed with the current latency 220, which may be an average or mean value, to generate an error signal e(k) 220. The error signal is provided to a controller 206. The controller also receives a relation parameter \hat{b}(k). The relation parameter represents the relationship between the time to generate an inference and the level of compression.

More specifically, the control plant 218 contains the module responsible for determining the current latency y(k). The current latency is measured for all tasks (e.g., all functions and computations performed in the neural network that are performed to generate an inference or an output). The current latency is thus measured for all tasks and may be aggregated with a function, which could be a mean by way of example. The control plant 218 thus measures or determines a current latency.

The current latency and the current compression ratio are fed into the adaptation engine 214. The adaptation engine 214 estimates the value of the relation parameter \hat{b}(k) using, for example, recursive least squares (RLS) or online learning algorithms, or the like. The controller 206 can then generate a control action [symbol] (k) based on the relation parameter that changes the level of compression.

The change in compression is determined or directed in box 210 and an updated level of compression or compression change Δu(k) is provided to the adaptation engine 214. This is combined with the current latency y(k) to generate a new or updated relation parameter \hat{b}(k).

The controller is able to combine an error signal 204 with the relation parameter 208 to update the compression level. The new compression level is then applied to the neural network and the process is repeated to dynamically adjust the compression level of the neural network.

More specifically, the pipeline engine 200 in FIG. 2 is employed to control the compression or the compression ratio of the neural network. As previously stated, the latency is measured for all tasks and aggregated with some function, which could be the mean. Afterwards, this latency value or signal and the current compression ratio are fed to the adaptation engine 214. The adaptation engine 214 estimates the value of the current compression parameter that relates the latency signal and the compression ratio, using the Recursive Least Squares (RLS) methodology, or other Online Learning algorithm. The controller 206 takes the relation parameter \hat{b}(k) and calculates a control action that changes the level of compression of or the compression ratio applied to the neural network.

In one example, compression is achieved by masking nodes and/or connections in the neural network. In particular, the neural network is configured to accept a masking parameter. This masking parameter may be a flag that indicates to the inference procedure whether calculations must or must not be performed in a given weight node. Formally, the neural network f(x, Θ, Ω) is augmented with a masking parameter m, which is a vector in {0,1}^{|Θ|} space, where |·| denotes a cardinality of a set. The resulting neural network performs f(x, Θ, Ω, m) and has negligible increase in storage size, because one more bit is added for each weight. If storage is a concern, a quantization schema can be employed to reduce the size of Θ beforehand.

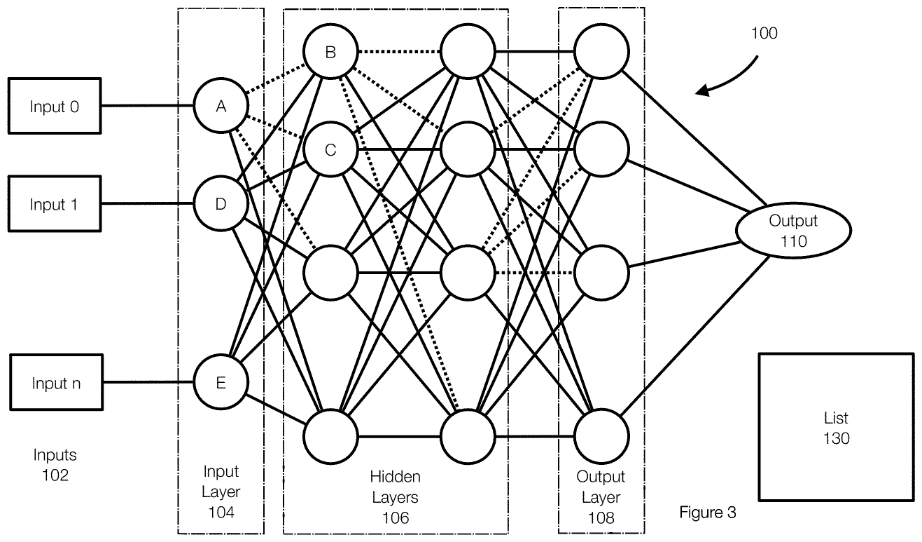

FIG. 3 illustrates an example of the neural network 100 shown in Figure after compression or after masking the neural network as determined by the neural network engine. In one example, a list of the index of each weight is maintained. The list may be sorted from the higher magnitudes to the lesser magnitudes. This list may, by way of example and not limitation, be node specific, layer specific, or neural network specific. In other words, lists can be maintained at different scales. This allows specific connections of a specific node to be masked or to mask connections based on a consideration of multiple nodes. A level of compression p is then applied. This applies a mask to the last n weights, where n is defined by n=|Θᵢ|·p.

In this example, the control action may remove the smallest weights or the weights that have the smallest impact on the inference or the output. Thus, FIG. 3 illustrates the neural network 100 after masking based on a list 130. In FIG. 3, the dashed lines represent the masking that has occurred in response to the control action generated by the pipeline engine 200. Advantageously, these adaptations are computationally efficient and often require little memory usage.

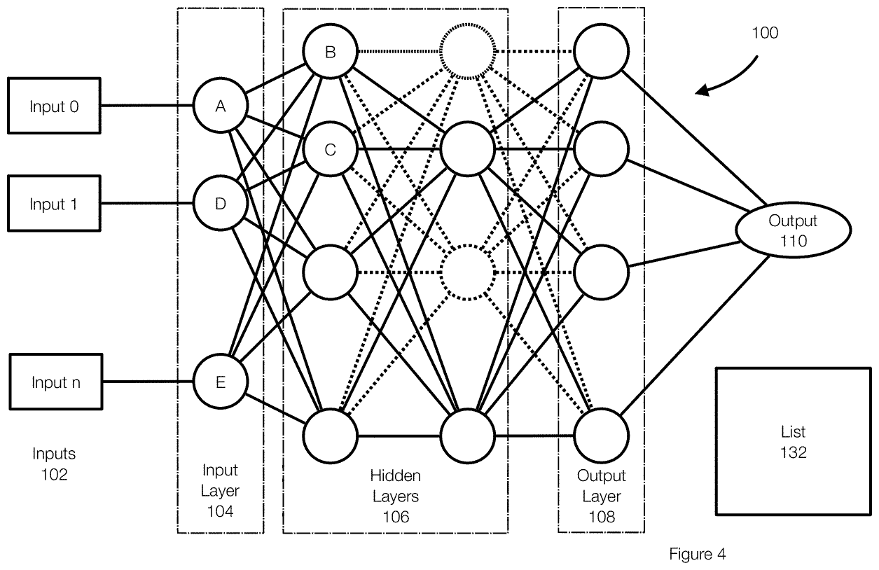

FIG. 4 illustrates the neural network 100 of FIG. 1 when the nodes themselves are masked. Instead of removing weights of smaller magnitude, all weights of a node with a smaller contribution are removed or masked based on a list 132, which may be different from the list 130. This can be done by aggregating the weights that flow out of a node with an aggregation function, which could be a mean. In this example, the list 132 may store the aggregated weights that flow out of a node. The nodes with the lowest aggregation or mean, subject potentially to a threshold, may be masked.

FIGS. 3 and 4 thus illustrate that masking can be applied to prune or mask weights and/or nodes of the neural network.

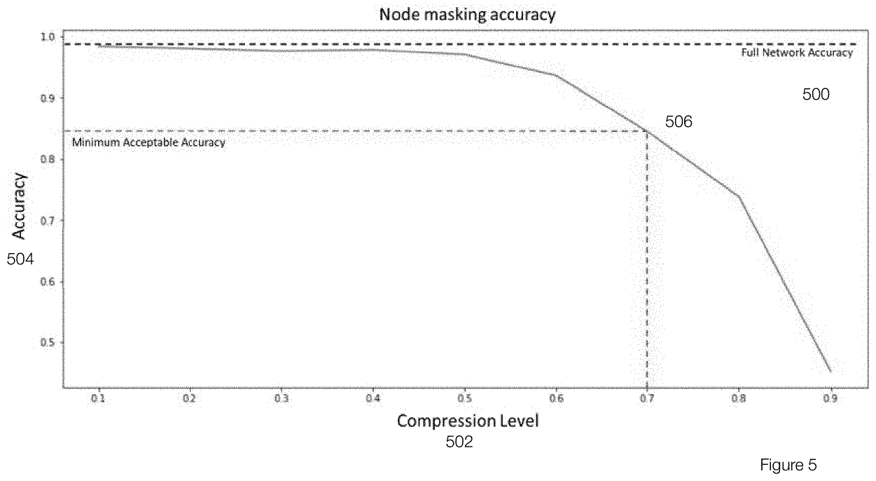

FIG. 5 illustrates the impact of masking on a neural network and illustrates that embodiments of the invention control masking to prevent catastrophic forgetting. Generally, compressing a neural network has an impact on the performance of the neural network. Fewer nodes or neurons may lead to reduced accuracy. As a result, a masked network will slowly lose performance. At some level of compression, the performance loss becomes more steep and accuracy is unreliable. FIG. 5 illustrates a graph 500 that illustrates how the compression level 502 impacts the accuracy 504. Embodiments of the invention may find the point of compression 506 at which further compression is discouraged or not permitted. This point of compression 506 may correspond to an upper bound and may be related to the minimum acceptable accuracy of the neural network. In some examples, this point of compression may be determined beforehand and can, in one example, be derived from a validation accuracy for crescent compression levels as illustrated in FIG. 5.

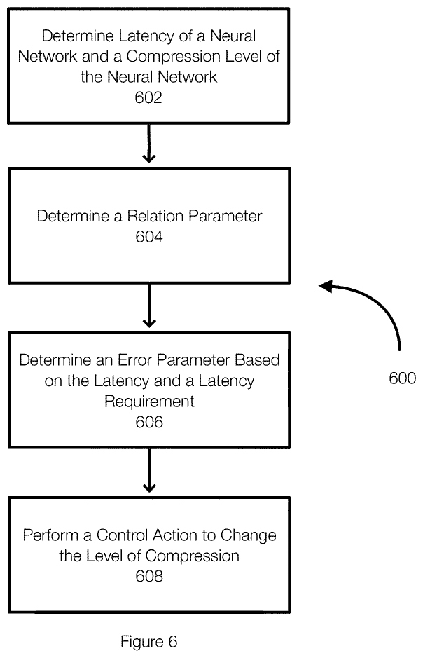

FIG. 6 illustrates a method for dynamically adapting a neural network. The method 600 may begin at any stage of the pipeline described herein. In this example, the latency and/or compression level of a neural network is determined 602. The latency can be measured, estimated and may be a mean of all latencies associated with the neurons or nodes of the neural network.

A relation parameter is then determined 604 from the latency and current compression level. This may be achieved using machine learning recursive least squares or other methodology. The relation parameter effectively describes a relationship between the current compression level and the current latency.

In this example, an error parameter or signal is determined 606 from the latency of the neural network and an expected or required latency. A controller may then perform 608 a control action based on the error signal or parameter and the relation parameter. Examples of the control action include increasing the compression, reducing the compression, or keeping the same level of compression. The compression can be achieved on a connection basis and/or a node basis as previously described. This process typically repeats such that the compression level dynamically adapts to changing conditions. Further, the control action may be limited in the sense that compression that may result in catastrophic forgetting is prevented. One goal is to ensure good enough accuracy.

Embodiments of the invention thus relate to a dynamic control-based mechanism to compress neural networks in order to comply with latency requirements or other SLOs. Embodiments of the invention allow the level of compression to be dynamically adapted and changed. This allows embodiments of the invention to balance the constraint of latency with the quality of the inference. In some examples, a hard upper bound is set on network compression to prevent catastrophic forgetting and, thus, maintain close to full neural network accuracy.

This allows real time ML analytics with hard latency requirements. Embodiments of the invention allow usage of neural networks in applications with hard latency requirements by diminishing the number of required operations at inference time. Furthermore, because there is trade-off between compression and performance of ML, measured in terms of accuracy, the proposed mechanism achieves optimal accuracy for a given neural network with a given hard constraint of time.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, neural network operations. Neural network operations may include compression, re-enlarging or dynamic compression/decompression of a neural network. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example public cloud storage environments in connection with which embodiments of the invention may be employed include, but are not limited to, Microsoft Azure, Amazon AWS, and Google Cloud. More generally however, the scope of the invention is not limited to employment of any particular type or implementation of cloud storage.

In addition to the storage environment, the operating environment may also include one or more clients that are capable of collecting, modifying, and creating, data. As such, a particular client may employ, or otherwise be associated with, one or more instances of each of one or more applications that perform such operations with respect to data.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take various forms, such as a .VMDK file for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

Following are some further example embodiments of the invention. These are presented only by way of example and are not intended to limit the scope of the invention in any way.

Embodiment 1. A method for dynamically adapting a neural network, the method comprising determining a latency associated with the neural network, determining a current compression level applied to the neural network, determining a relation parameter that relates the latency with the current compression level, adjusting a compression ratio based on the relation parameter, and applying the compression ratio to the neural network.

Embodiment 2. The method of embodiment 1, further comprising adjusting the compression ratio such that the latency is less than or equal to a required latency.

Embodiment 3. The method of embodiment 1, and/or 2, further comprising adjusting the compression ratio without causing catastrophic forgetting in the neural network.

Embodiment 4. The method of embodiment 1, 2, and/or 3, wherein applying the compression ratio includes compressing the neural network or re-enlarging the neural network.

Embodiment 5. The method of embodiment 1, 2, 3, and/or 4, further comprising applying the compression ratio by masking weights in the neural network.

Embodiment 6. The method of embodiment 1, 2, 3, 4, and/or 5, further comprising applying the compression ratio by masking nodes in the neural network.

Embodiment 7. The method of embodiment 1, 2, 3, 4, 5, and/or 6, further comprising applying a masking parameter that determines whether an inference procedure is or is not performed in a given weight node of the neural network.

Embodiment 8. The method of embodiment 1, 2, 3, 4, 5, 6, and/or 7, further comprising configuring the neural network to accept a masking parameter.

Embodiment 9. The method of embodiment 1, 2, 3, 4, 5, 6, 7, and/or 8, further comprising repeatedly adjusting the compression ratio based on the latency and the current compression level, wherein the latency and the current compression level are determined periodically or continuously.

Embodiment 10. The method of embodiment 1, 2, 3, 4, 5, 6, 7, 8, and/or 9, further comprising determining the relation parameter using recursive least squares or a learning algorithm.

Embodiment 11. A method for performing any of the operations, methods, or processes, or any portion of any of these, disclosed herein.

Embodiment 12 A non-transitory storage medium having stored therein instructions that are executable by one or more hardware processors to perform the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the Figures and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein.

The physical computing device includes a memory which may include one, some, or all, of random access memory (RAM), non-volatile random access memory (NVRAM), read-only memory (ROM), and persistent memory, one or more hardware processors, non-transitory storage media, UI device, and data storage. One or more of the memory components of the physical computing device may take the form of solid state device (SSD) storage. As well, one or more applications may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for dynamically adapting a neural network, the method comprising:
determining a latency associated with the neural network;
determining a current compression level applied to the neural network;
determining a relation parameter that relates the latency with the current compression level;
adjusting a compression ratio based on the relation parameter; and
applying the compression ratio to the neural network.

2. The method of claim 1, further comprising adjusting the compression ratio such that the latency is less than or equal to a required latency.

3. The method of claim 2, further comprising adjusting the compression ratio without causing catastrophic forgetting in the neural network.

4. The method of claim 1, wherein applying the compression ratio includes compressing the neural network or re-enlarging the neural network.

5. The method of claim 1, further comprising applying the compression ratio by masking weights in the neural network.

6. The method of claim 1, further comprising applying the compression ratio by masking nodes in the neural network.

7. The method of claim 1, further comprising applying a masking parameter that determines whether an inference procedure is or is not performed in a given weight node of the neural network.

8. The method of claim 1, further comprising configuring the neural network to accept a masking parameter.

9. The method of claim 1, further comprising repeatedly adjusting the compression ratio based on the latency and the current compression level, wherein the latency and the current compression level are determined periodically or continuously.

10. The method of claim 1, further comprising determining the relation parameter using recursive least squares or a learning algorithm.

11. A non-transitory storage medium having stored therein instructions that are executable by one or more hardware processors to perform operations comprising:
determining a latency associated with the neural network;
determining a current compression level applied to the neural network;
determining a relation parameter that relates the latency with the current compression level;
adjusting a compression ratio based on the relation parameter; and
applying the compression ratio to the neural network.

12. The non-transitory storage medium of claim 11, the operations further comprising adjusting the compression ratio such that the latency is less than or equal to a required latency.

13. The non-transitory storage medium of claim 12, the operations further comprising adjusting the compression ratio without causing catastrophic forgetting in the neural network.

14. The non-transitory storage medium of claim 11, wherein applying the compression ratio includes compressing the neural network or re-enlarging the neural network.

15. The non-transitory storage medium of claim 11, the operations further comprising applying the compression ratio by masking weights in the neural network.

16. The non-transitory storage medium of claim 11, the operations further comprising applying the compression ratio by masking nodes in the neural network.

17. The non-transitory storage medium of claim 11, the operations further comprising applying a masking parameter that determines whether an inference procedure is or is not performed in a given weight node of the neural network.

18. The non-transitory storage medium of claim 11, the operations further comprising configuring the neural network to accept a masking parameter.

19. The non-transitory storage medium of claim 11, the operations further comprising repeatedly adjusting the compression ratio based on the latency and the current compression level, wherein the latency and the current compression level are determined periodically or continuously.

20. The non-transitory storage medium of claim 11, the operations further comprising determining the relation parameter using recursive least squares or a learning algorithm.
